(19) United States
(12) Patent Application Publication
(10) Pub. No.: US 2016/0332008 A1
(43) Pub. Date: Nov. 17, 2016

(54) Drop-down Respirator System

(71) Applicant: Glenn McAndrews, Lebanon, OH (US)

(72) Inventor: Glenn McAndrews, Lebanon, OH (US)

(21) Appl. No.: 14/714,305

(22) Filed: May 17, 2015

(51) Int. Cl. A62B 23/02; A62B 18/08; A62B 18/02; B01D 46/00; A62B 7/10

(52) U.S. Cl. CPC A62B 23/025; B01D 46/0015; B01D 46/0005; A62B 7/10; A62B 18/02; A62B 18/084

(57) ABSTRACT

A disposable half mask drop-down respirator system comprised of a face seal, mount, filter, frame, and straps; the disposable filter interposed between a removable frame and a mount adjoined to the face seal; the mount/face seal assembly supported on the user's face by one or more straps; the frame adjoined to the mount in a manner that allows rotation about the mount between open and closed positions, the former position used at times when it is necessary to eat, drink, smoke, or talk, without having to remove the entire respirator system and the latter position used at times when it is necessary to filter inhaled or exhaled air.

### CROSS-REFERENCE TO RELATED APPLICATIONS

This application claims the benefit of U.S. Provisional Application 62/028,285 filed 23 Jul. 2014, incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to personnel protection equipment. More particularly, the present invention is a respirator system used to protect the user from ambient dust and other objectionable airborne particles that potentially can be inhaled through the mouth or nose. Common terms used to describe these devices are “half-mask respirator” or “filter mask”. Additionally, these devices are worn by medical workers to protect patients from pathogens or other biological hazards that may be exhaled by the user. These devices are commonly sold in hardware stores or provided by medical supply companies.

### BACKGROUND OF THE INVENTION

Many home improvement, industrial, and construction projects involve operations that create dust and the like. Such operations include but are not limited to sanding, grinding, mowing, harvesting, sawing, painting, and spraying. Personnel working in such environments are required, or otherwise wise to wear filtering masks, including the disposable type, to help reduce the amount of airborne particles inhaled into the lungs. The most common of these is the filter mask made of multi-laminate paper/polypropylene material shaped to the contour of the human face, covering mouth and nose, and attached to the head using one or more elastic straps. Examples of these masks are disclosed in U.S. Pat. No. 4,536,440 to Berg, U.S. Pat. No. 4,807,619 to Dyrud et al., U.S. Pat. No. 6,394,090 to Chen, and U.S. Pat. No. 7,131,442 to Kronzer et al. Such masks and respirators, because of their benefit to the health and well-being of the user, must not be uncomfortable, or burdensome, lest the user be discouraged from using the device.

In use, the common disposable mask used by medical or construction workers has many limitations. Most limiting is the inability to quickly and temporarily remove or re-install the mask; a necessity in such cases as talking, smoking, ingesting food and beverages, or replacing the filter element. In both medical and construction environments it is common that gloves, headwear, and filter masks be worn together. As such, manipulation of the thin head straps or the thin flexible filter element is difficult if not impossible. The problem is eloquently described in Seppala's U.S. Pat. No. 5,237,986. Other inventions, including Byram's U.S. Pat. No. 6,119,692, and Nelson's U.S. Pat. No. 4,860,121 recognizes the need to temporarily displace the mask from the face and then conveniently facilitate its return to the operating position in those situations previously described.

Additionally, the majority of disposable masks are ill-fitting, compromising their functionality and their corresponding filter rating. This problem is well recognized in the field and addressed by recent inventions like U.S. Pat. No. 8,066,006B2 granted to Daugaard et al. adding built-in nose clips and the like. The desired disposability of such masks, including their economical cost, should only apply to the filter element and not the face sealing features. A disposable filter mask system that embodies that belief was invented as early as 1924 in U.S. Pat. No. 1,502,450 by Wood. Wood's device however lacks the quick donning benefit afforded by the present invention. Building on Wood's invention, U.S. Pat. No. 6,817,362 by Gélinas also puts the disposable filter in between a face seal and a cover but makes no attempt at creating open/closed positions of the cover that would permit talking, eating, etc. Nor are there adequate provisions in the face-piece for passing food or beverage.

It is therefore an object of the present invention to provide a respirator system that: 1) supports a disposable filter, 2) provides an effective face seal, 3) is comfortable to wear, 4) is economical, 5) can be manipulated by the user even when wearing gloves, 6) quickly changes from “talking/eating mode” to “respiratory-protection” mode; readily accessible in either position, 7) permits replacing the disposable filter without removing the respirator, and 8) isolates the filter from the user's skin.

### SUMMARY OF THE INVENTION

Briefly described, a respirator system is disclosed for use by personnel in those situations where it is necessary to filter the user's exhalation or inhalation. The present invention is comprised, in combination, of the following components: a face seal, mount, one or more head and neck straps, frame, and filter. The face seal, as the name implies, is the deformable component generally conforming to surround the user's nose and mouth, containing an opening exposing both nose and mouth. A rigid mount attaches to the face seal. It too contains an opening designed to expose the nose and mouth. The mount further contains strap-receiving buttons used to attach the head and neck straps. The upper portion of the mount further contains rectangular clip-receiving apertures. The lower portion of the mount contains one half of a hinged joint. The other half of the hinged joint is attached to the frame. When the two halves of the hinged joint are joined together, the combination of frame and mount can open or close like a clamshell. The frame additionally contains two male spring clips used to mate with two female apertures in the mount; the mated pair of clip and aperture being hereafter referred to as a “lock”. Once the frame and mount are co-joined through the hinged joint, the frame may be rotated upward to bring the clips and apertures into alignment. Further rotation of the frame will result in the clips inserting through the apertures forming two locks. When no further rotation is possible, the clips in their free state, provide positive retention of the frame against the mount. When depressed and pushed away from the user's nose, the clips disengage from the apertures permitting downward rotation of the frame. The frame is free to hang below the user's chin. Further rotation of the frame permits its complete removal from the mount.

Other means of locking or securing the frame against the mount (in the upright “filtering position”) are anticipated such as magnets, pushbuttons, push-tabs, etc. but none of these will be discussed or shown.

Interposed between frame and mount, a semi-rigid disposable filter is held in place by retention features provided in the frame.

### BRIEF DESCRIPTION OF THE DRAWINGS

The advantages and features of the present invention will become better understood with reference to the more detailed description and drawings wherein like numerals are employed to designate like parts throughout the drawings and:

FIG. 1 is a perspective view of the respirator system;

FIG. 2 is a side view of the respirator system;

FIG. 3 is a perspective view the respirator system's closed position;

FIG. 4 is a perspective view the respirator system's mount and dislodged frame;

FIG. 5 is a perspective view of a filter;

FIG. 6 a,b,c are fragmentary sectional views taken through the hinged joint;

FIG. 7 depicts the invention in use; both open and closed positions;

FIG. 8 depicts the invention in use; a user removing the frame.

### DETAILED DESCRIPTION OF THE INVENTION

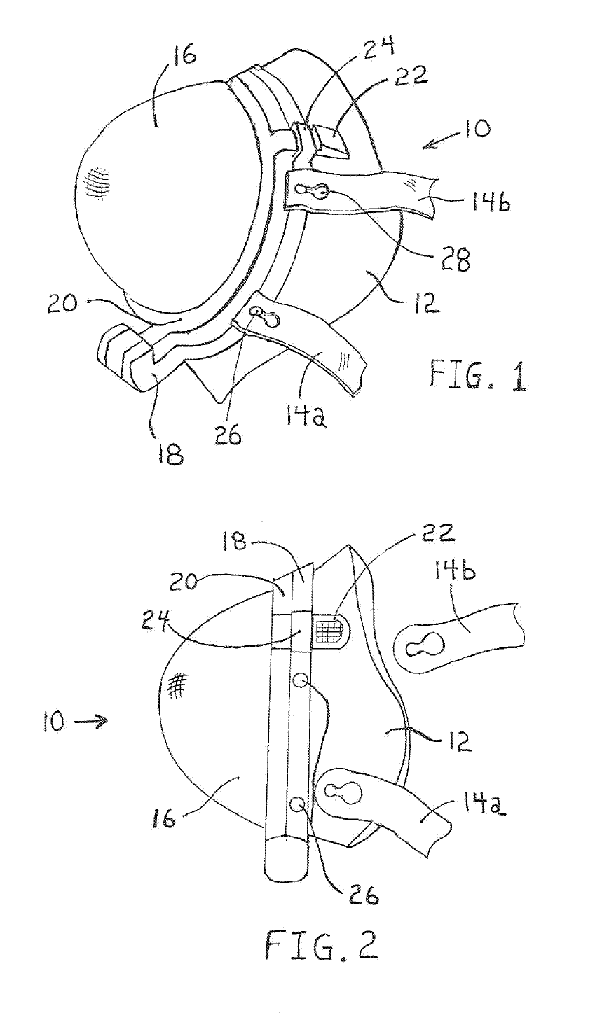

Referring now to the present invention in more detail, in FIG. 1 there is shown respirator system 10 comprised of face seal 12, neck strap 14a, head strap 14b, filter 16, mount 18, and frame 20. Mount 18 contains apertures 24 and buttons 26. Buttons 26, shaped like small mushrooms, project outward from mount 18 and provide an attachment point for straps 14a and 14b. Frame 20 contains spring clips 22. Both straps 14a and 14b contain hourglass shaped button holes 28 allowing them to be secured to buttons 26.

Referring now to the present invention in more detail, in FIG. 2 there is shown respirator system 10 of FIG. 1, rotated to show the side view. Different from FIG. 1, neck strap 14a, and head strap 14b of FIG. 2 are not connected to buttons 26 in order to better depict the well-known button-hole means of attachment.

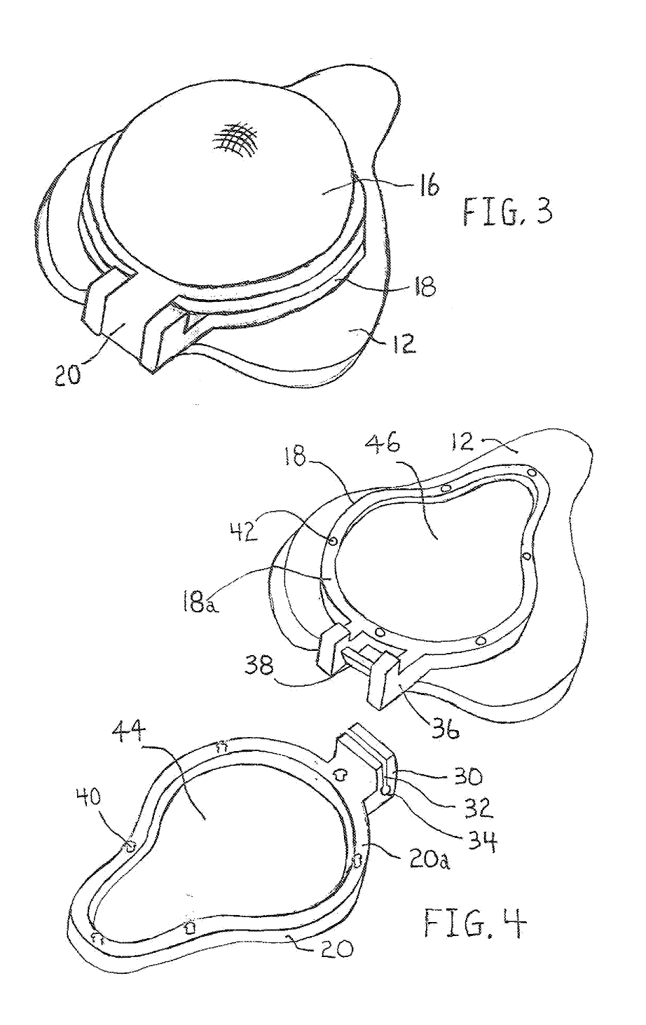

Referring now to the present invention in more detail, in FIG. 3, FIG. 4, and FIG. 5, there is shown frame 20 and mount 18. In FIG. 3, frame 20 is joined to and rests atop mount 18. In FIG. 4 frame 20 is dislodged from mount 18 to better show the details of the hinged joint connecting these two components as well as mount flange 18a, frame flange 20a, frame opening 44, and mount opening 46. Side members 36 extend upward from the bottom of mount 18. Crossbar 38 transits the open gap between side members 36.

Extending from frame 20, tower 30 contains slot 32 and circular recess 34. The width of tower 30 is slightly smaller than the width of crossbar 38 allowing it to be interposed between side members 36. The width and height of crossbar 38 are such that once agreeably inserted in slot 32, and agreeably resting in recess 34, recess 34 and frame 20 can rotate freely about crossbar 38. The union of the lower portions of mount 18 and frame 20 is made possible by the retention of crossbar 38 in recess 34.

A plurality of pins 40 protrude vertically upward from frame flange 20a and a like number of mount holes 42 recede into mount flange 18a. Mount holes 42 are sized to cooperatively receive and engage with pins 40. Both flanges 18a and 20a are generally flat contiguous surfaces geometrically sized and shaped to align and mate with each other. With flanges 18a and 20a mated as such, pins 40 and mount holes 42 align, resulting in the insertion of pins 40 into mount holes 42.

FIG. 5 shows filter 16 containing border portion 16a and a plurality of mount holes 16b. Border portion 16a is generally a flat contiguous surface, the geometry of which is made to conform to overlay and reside on frame flange 20a after filter 16 has been inserted through frame opening 44. The size and spacing of mount holes 16b in border portion 16a are designed to align and cooperatively engage pins 40. Filter 16 captured between flanges 18a and 20a, with frame 20 locked against mount 18 (aka closed position) creates an air-tight seal such that when the user inhales, air can only pass thru filter 16 media.

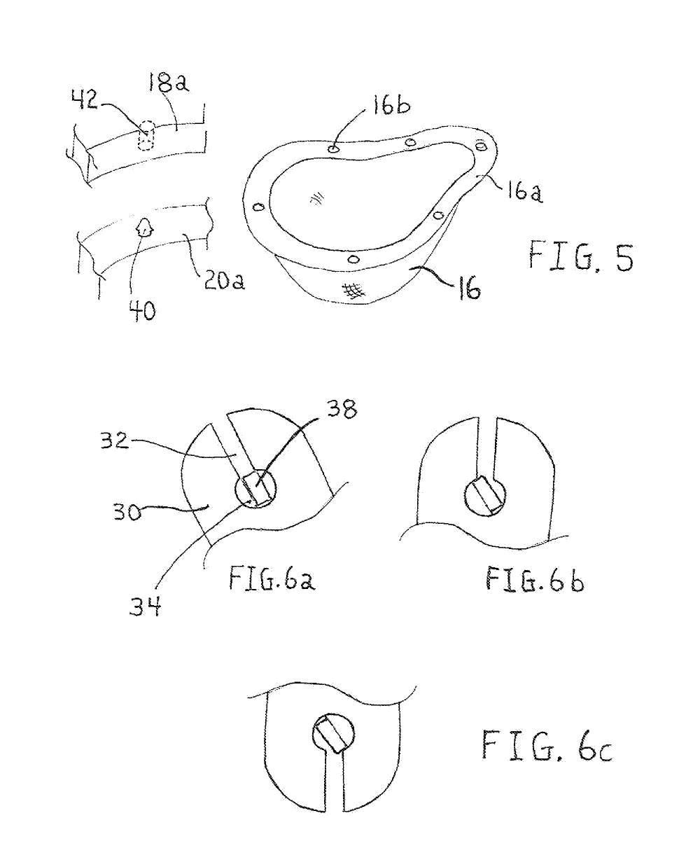

FIG. 6 a,b,c depicts the relationship between crossbar 38 and recess 34 after frame 20 has been mated to mount 18 by the union of tower 30 and side members 36. As shown in FIG. 6a, in order to join frame 20 to mount 18, it is necessary to position tower 30 such that slot 32 aligns with the long axis of crossbar 38; allowing then tower 30 to move in a direction that results in crossbar 38 resting in recess 34. In this mated configuration, tower 30 and subsequently frame 20, can rotate about crossbar 38. As shown in FIG. 6b and FIG. 6c, frame 20 and mount 18 are prevented from dislodging for any angular relationship of frame 20 and mount 18 other than the “insert” angular position depicted in FIG. 6a. FIG. 6b shows what the hinged joint looks like when frame 20 is hanging freely under the user's chin FIG. 6c shows what the hinged joint looks like when frame 20 is rotated up into the deployed position; this position being defined by the locks in their locked configuration.

The construction and assembly details of the present invention as shown in FIG. 1 through FIG. 8 are not unlike masks known in the prior art and available in stores today. Straps 14a and 14b are preferably each of one-piece elastic material or two-piece construction (left side/right side) using non-elastic material and buckles, snaps, VELCRO®, and the like, to join straps 14a and 14b behind the user's head. Face seal 12 is made of rubber, sponge, foam or other deformable material. Both frame 20 and mount 18 are each single-piece constructions made from thermoplastic or thermosetting polymers. Filter 16 material is not unlike the disposable mask material found in the prior art, commercially available, and meeting industry filtration standards (e.g. NIOSH N95). Because of the present invention's approach to mounting disposable filters in a “clamshell” arrangement, filter 16 does not require nose bridges and head bands. Optionally, filter 16 may however contain an exhalation valve also well known in the prior art (valve not shown). Mount 18 may be permanently joined to face seal 12 using glues and the like. Preferably, mount 18 is temporarily joined to face seal 12 in order to permit cleaning of face seal 12 (similar then to straps 14a and 14b). The deformable material of face seal 12 may be formed or molded to create recesses or channels (recesses or channels not shown) allowing an interference-fit insertion of mount 18.

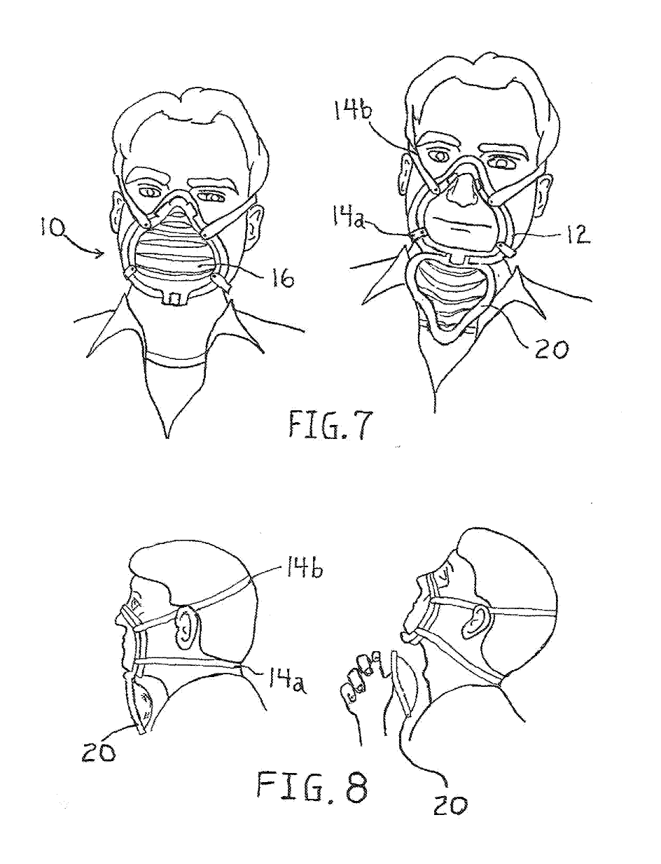

Referring now to FIG. 1, FIG. 5, FIG. 6, FIG. 7 and FIG. 8, the use of respirator 10 will be described. Like today's available masks, neck strap 14a and head strap 14b are used to secure respirator 10 to the user's face. In order to lower frame 20, say for the purpose of eating, the user simply has to depress spring clips 22 (releasing them from apertures 24) and pushing frame 20 away from the user's nose. Frame 20 will remain hanging below the user's chin supported by crossbar 38. To disengage frame 20 from respirator 10, say for the purpose of changing filter 16, the user simply has to continue rotation of frame 20 towards their neck, bringing into alignment slot 32 and crossbar 38 as shown in FIG. 6a. This action by the user is facilitated by tilting the head backward.

Advantages of the present invention include, without limitation, the following: 1. the respirator system uses only five components making it economical, 2. each component is a one-piece construction making the system highly producible, 3. joining the components can be performed by the user, 4. permits eating, drinking, changing filters, etc., without removing straps, 5. the respirator quickly changes from “filtering mode” to “smoking/drinking mode”, and 6. the filter is isolated from dirt and perspiration on the user's skin.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Having thus described my invention I claim:

1. A respirator system for filtering a user's inhalation or exhalation, comprising:
a face seal surrounding and exposing a user's nose and mouth;
a mount attached to said face seal, said mount containing:
an opening surrounding and exposing a user's nose and mouth,
strap attaching means,
a flange;
head or neck straps attached to said mount;
a frame, said frame containing:
an opening having sufficient geometry to expose a user's nose and mouth,
a flange; said flange containing filter retention means;
joining means between said frame and said mount, said joining means providing rotation and hanging support of said frame about and from said mount;
locking means between said frame and said mount;
a disposable filter, said filter further containing a border portion suitably configured to engage and attach to said flange of said frame;
whereby said filter interposed between said frame and said mount, the latter two components being locked together, provides a usage position protecting the user from inhaling airborne particles or filtering the user's exhalation; and
whereby said frame, unlocked from said mount, and together with said filter retained thereon, rotated below the user's mouth and nose, provides a usage position allowing the user to drink, eat, smoke, or talk.
